(19) United States
(12) Patent Application Publication
(10) Pub. No.: US 2007/0255607 A1
(43) Pub. Date: Nov. 1, 2007

(54) Business process automation system and methods of use thereof

(75) Inventors: P. William Staby, Brooklyn, NY (US); Scott Yu Shou, Brooklyn, NY (US)

Correspondence Address: BEYER WEAVER LLP, P.O. BOX 70250, OAKLAND, CA, 94612-0250, US

(73) Assignee: Phaon, Inc.

(21) Appl. No.: 11/158,026

(22) Filed: Jun. 20, 2005

(51) Int. Cl. G06F 9/46

(52) U.S. Cl. 705/8

(57) ABSTRACT

A method of interoperating with an electronic messaging service manages the execution of a business process. The method includes causing the electronic messaging service to present business process data to business process participants in enhanced electronic messages whereby business process participants can interact with the enhanced electronic messages. Reactions of business process participants to the enhanced electronic messages are received via the electronic messaging service.

### BACKGROUND

1. Technical Field

This application relates generally to a system and methods for automating enterprise business processes and, more specifically, to the simultaneous communication of enterprise data and related dialog to human and system resources according to pre-defined and user-controlled business process models and rules.

The application describes computer software that works in concert with any number of electronic messaging systems to cost-effectively provide automation benefits to enterprises.

2. Description of Related Art

Recent developments in computer software have provided enterprises with a number of different options for automating workflow. These options include: (i) large-scale workflow automation applications e.g. enterprise resource planning (ERP), supply-chain management (SCM), customer relationship management (CRM), business process management (BPM) and the like; (ii) specialized desktop workflow management applications e.g. project management, workflow, collaboration and the like; and (iii) portal applications. What is common to these various workflow automation solutions is that they are: (i) expensive; (ii) difficult to modify; (iii) hard for average people to adopt and use.

What is desired is a relatively inexpensive, flexible and user-friendly automation solution that, for example: (i) can be cost-effectively deployed to small workgroups; (ii) can be easily modified by workgroup participants; (iii) has a familiar, easy-to-use interface; and (iv) allows users immediate access to selected enterprise data and related contextual dialog in a unified package.

### SUMMARY OF THE INVENTION

The application pertains to methods and systems for automating workflow in ways that allow enterprises to: (i) increase the speed at which they can adapt to changes in their business environment; (ii) capture and use data about workflow more effectively; and (iii) lower the costs of making workflow improvements.

One example described herein is a computer-implemented process that converts common electronic messaging systems into effective workflow automation solutions.

One aspect effects certain changes to the client-side interface and functions of standard electronic messaging client applications (whether presently-existing or heretofore developed and/or released), e.g. Microsoft Outlook™ and IBM Lotus Notes,™ and thereby enhances their utility as workflow automation tools. This is referred to as the enhanced client. In other examples, a client is provided but is not “modified” per se but, rather, may be a customized client application including standard electronic messaging functions as well as the enhanced functions. That is, there is not a limitation to modified existing electronic messaging systems. In fact, much of the description uses the term “enhanced client,” and any client having appropriate functionality (whether “modified” or not) may generally be employed.

Another aspect (the “service”) works in concert with server-side electronic messaging applications (again, whether presently-existing or heretofore developed), e.g. Microsoft Exchange™ and IBM Lotus Domino,™ to manage interactions between the enhanced client and enterprise systems, including an electronic messaging server. The service may operate independently of server-side electronic messaging applications. The service need not be limited to being located on one particular computer and may be distributed or otherwise configured to function to orchestrate the workflow.

### BRIEF DESCRIPTION OF THE DRAWINGS

FIG. 1 depicts a hierarchy of the different ways in which workflow is typically automated by enterprises and positions the Invention within that hierarchy based on criteria that include cost, flexibility, structure and ease-of-use.

FIG. 1 is intended to provide the reader with a clear understanding of how an electronic messaging platform can be used as an effective workflow collaboration and data transportation foundation and can, therefore, provide an ideal balance among the attributes listed above.

FIG. 2 illustrates a basic system architecture using an example of information flows that take place between human and system resources.

FIG. 3 illustrates an example of basic actions taken when an e-mail is conveyed from the service to the enhanced client and back again.

FIG. 4 illustrates an example of a user interaction with the enhanced client that results in the execution of a serial workflow.

FIG. 5 illustrates an example of a user interaction with the enhanced client that results in the execution of a parallel workflow.

FIG. 6 illustrates an example of a user interaction with the enhanced client that results in the execution of a “modify” workflow.

FIG. 7 illustrates a more detailed example of service actions related to processing e-mails including how they are built.

FIG. 8 illustrates a more detailed example of service actions related to building an e-mail message.

FIG. 9 illustrates an example of the enhanced client.

FIG. 10 illustrates two examples of normal workflow interactions.

FIG. 11 illustrates an example of a parallel workflow interaction.

FIG. 12 illustrates several examples of “modify” workflow interactions i.e. wherein a user participating in a workflow, makes “mid-course” changes to a workflow that do not conform to the previously-defined workflow model.

FIG. 13 illustrates the “start process” button within an exemplar enhanced client application—in this case Microsoft Outlook.™ The “start process” button is used to initiate a workflow.

### DETAILED DESCRIPTION OF SELECTED EMBODIMENTS

Detailed reference will now be made to examples with reference to the accompanying drawings. It will be understood that the example(s) shown is not intended to, in any way, limit the claims to any particular example. To the contrary, the example(s) shown is intended to illustrate to one of ordinary skill in the art various alternatives, modifications and equivalents as may be included within the spirit and scope of the claims.

1. Introduction

With rapid advances in communication and search technology allowing consumers faster access to accurate information, enterprises are under increasing pressure to deliver higher-quality products and services at lower cost. Their response is to look for opportunities to improve productivity, lower costs, and increase flexibility i.e. the capability to quickly adapt to market-driven change. One way they do this is to automate workflows wherever possible and this explains why there are many workflow management software applications on the market today.

Some fundamental problems with workflow management software applications on the market today are: (i) each has a highly specialized function; (ii) each has a unique user interface; and (iii) every workflow participant must utilize that particular application. The result is: (i) significant resistance to use; (ii) high initial licensing cost; (iii) increased burden on IT departments to support multiple applications; and (iv) difficulty communicating with workflow participants who don't have the same application.

The uniqueness of the described system centers on the fact that it leverages the ubiquity and familiarity of any electronic messaging medium into a low-cost, minimally invasive, user-friendly system for workflow automation and improvement.

Some important decision criteria companies use to evaluate different workflow management software applications are: (i) solution effectiveness, and (ii) solution cost.

Two basic criteria are often used in the determination of solution effectiveness: (i) adequate flexibility to adapt to and fulfill a set of workflow requirements, and (ii) adequate structure to satisfy a set of workflow requirements consistently and controllably. Flexibility is measured by, for example: (1) ability to integrate into various technical environments, and (2) speed at which workflows can be changed. Structure is measured by: (1) consistency of execution, and (2) audit ability.

Three basic criteria are often used in the determination of solution cost: (i) initial purchase price, (ii) implementation and on-going maintenance costs, and (iii) training/change-management costs.

There is, however, one criterion that has a profound effect on both solution effectiveness and solution cost i.e. user adoption rate. For workflows that require a high degree of human interaction across a number of different boundaries (e.g., departmental, geographic, technical, etc.), having a common communication platform that is familiar and easy to use will have a positive effect on both solution effectiveness (widely adopted, faster response times) and cost (less training, no system incompatibility issues).

The described Workflow automation methodology/system attempts to strike a good balance between effectiveness and cost.

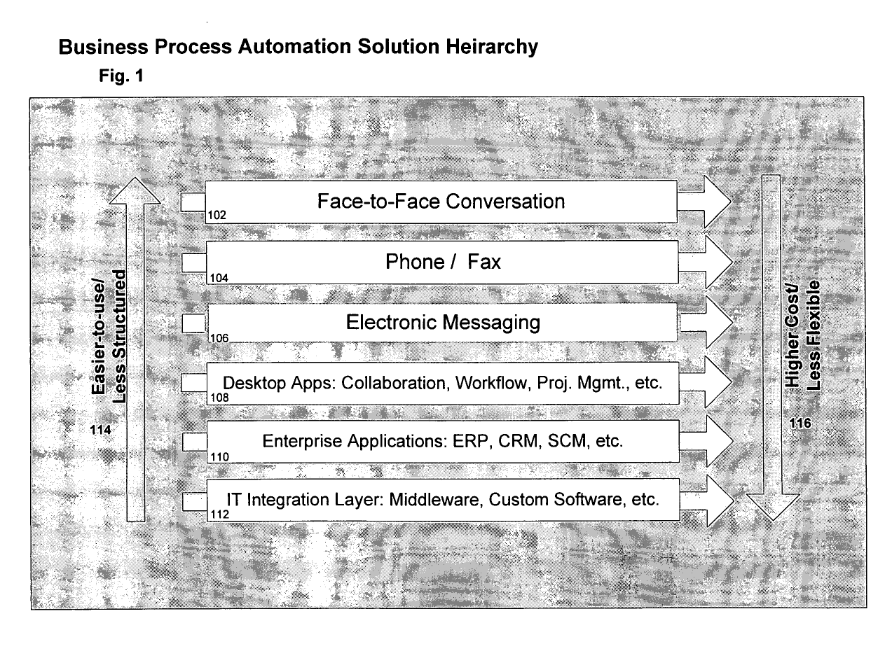

FIG. 1—The Business Process Automation Solution Hierarchy

FIG. 1 depicts the different ways companies automate workflow ranging from the most human-driven and unstructured (top), to the most machine-driven and structured (bottom).

Item 102

Face-to-face conversations, whether they take place in the office or elsewhere, are an important method by which critical workflow-related information is communicated. This method of workflow automation is easy, flexible, virtually-cost-free and completely unstructured.

Item 104

Phone and fax based communications represent the next level in the hierarchy where specific, higher-cost technologies are deployed and a modest degree of structure is imposed.

Item 106

Electronic messaging technologies, including e-mail and instant messaging, are low-cost technologies that are widely accepted (approximately 600 million people worldwide use them in some form) and very easy to use.

With e-mail and other types of electronic messaging, it is quite simple to create and modify repeatable communication patterns (example: mailing lists). By logical extension, structured communication patterns are also useful as workflow models because they specify defined populations and certain sequences of events. In addition, e-mail messages are structured because their movement and contents can be accurately tracked and reported (audited).

This is the workflow automation level at which the described example operates.

Item 108

The desktop application layer represents several categories of software including: (i) collaboration tools, (ii) workflow managers, and (iii) project managers that can be used to automate workflow. Each type of software has specialized functions, requires a high degree of human skill to operate and, therefore, has a correspondingly greater need for specialized training and knowledge.

Although desktop applications typically cost much less than the next two layers below, they have hidden costs in the form of low user adoption rates. They do, however, allow different degrees of flexibility and structure depending on the specific software application and its intended use.

Item 110

This workflow automation layer represents enterprise applications i.e., applications that are deployed enterprise-wide to control a critical end-to-end workflow e.g., ERP (Enterprise Resource Planning), CRM (Customer Relationship Management), or Supply Chain Management (SCM).

Enterprise applications are very costly with six- seven-figure initial license fees plus implementation and customization expenses that are often a multiple of initial license fees the norm. Enterprise applications are highly structured in that their main purpose is to execute workflows according to standardized patterns that can be easily monitored and audited. However, because enterprise applications are complex and typically require highly-trained personnel to administer them, they are highly inflexible.

Item 112

This workflow automation layer represents custom-built software, integration platforms (middleware) and customized integration interfaces between different IT systems.

Despite the fact that they have virtually the same ease-of use, cost, flexibility and structure characteristics as the layer above, they occupy the bottom-most rung because they have an added degree of risk i.e. (i) they may utilize proprietary technologies that are, or will be, obsolete, and (ii) they depend upon key in-house personnel for continued operation.

Item 114

This arrow illustrates the fact that as one moves from bottom to top in the workflow automation hierarchy, the solutions become more familiar and easy-to-use while at the same time they provide less structure.

Item 116

This arrow illustrates the fact that as one moves from top to bottom in the workflow automation hierarchy, the solutions become more costly and less flexible.

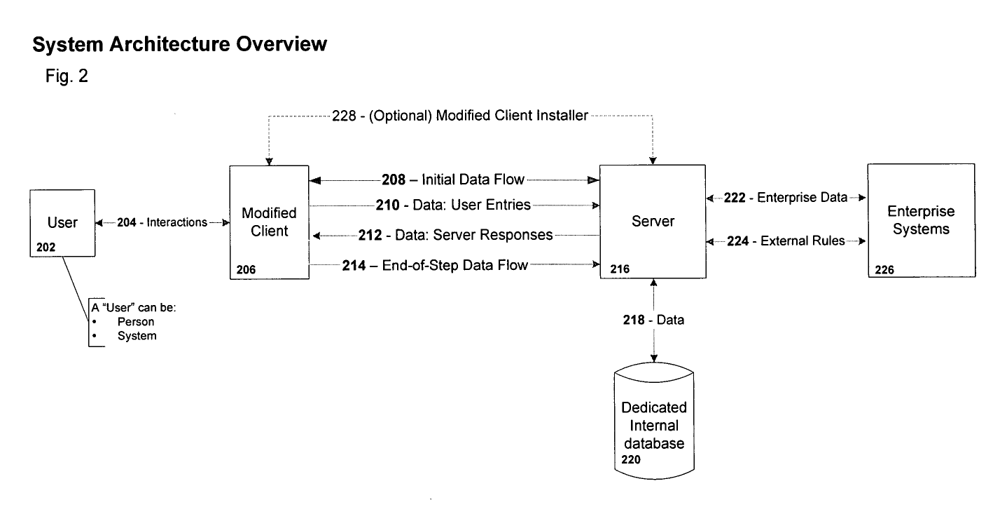

FIG. 2—System Architecture Overview

FIG. 2 provides a general overview of the example's system architecture.

Item 202—Definition of “User”

This item depicts a user. A “user” is defined as either a person who is involved in a particular workflow, or a system resource (e.g. a database application) whose actions may take the place of a person in a workflow step.

Item 204—User/Enhanced Client Interaction

This arrow represents the fact that users interact with the enhanced client application through an off-the-shelf e-mail client application, e.g. Microsoft Outlook™, Lotus Notes™ or other web-based client, which has been modified by the enhanced client application. The “off-the-shelf” aspect is not limited only to presently-available products; it includes products that may be developed in the future. Furthermore, it should be noted that customized clients may also be employed. For ease of description, all are hereinafter referred to as “enhanced client.” Through the enhanced client, users may carry out all normal e-mail related tasks as well as additional workflow-related tasks (described in further detail in Item 206). System resources interact with the enhanced client through the same adapters used by the service. The specific adapters system resources may use are described in items, 210 and 214.

Furthermore, it should be noted that reference is made throughout to the term “e-mail.” The term “e-mail” should be construed to mean an electronic message of any form (conveyed by an electronic messaging system of any kind, whether now known or hereinafter developed) and, furthermore, the example illustrates an electronic message that is unique in that it may include an embedded electronic form that provides workflow participants with controlled access to enterprise data without the need for them to interact directly with the specific enterprise systems themselves. As such, the example illustrates a point-to-point system for pushing enterprise data directly to workflow participants depending upon their specific role or position within the workflow

Item 206—The Enhanced Client Application

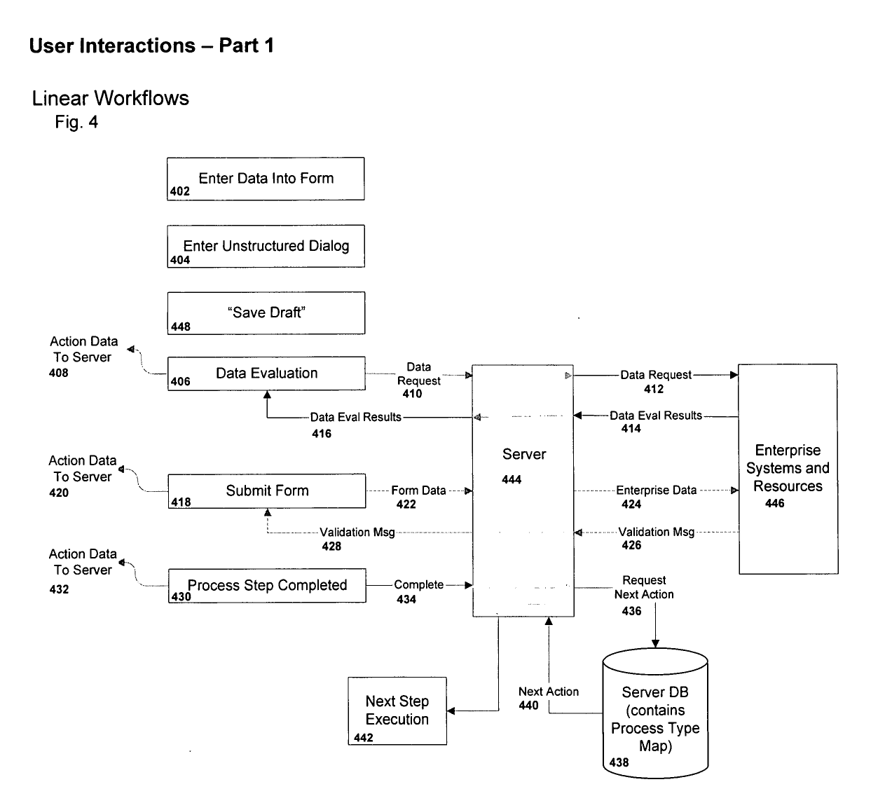

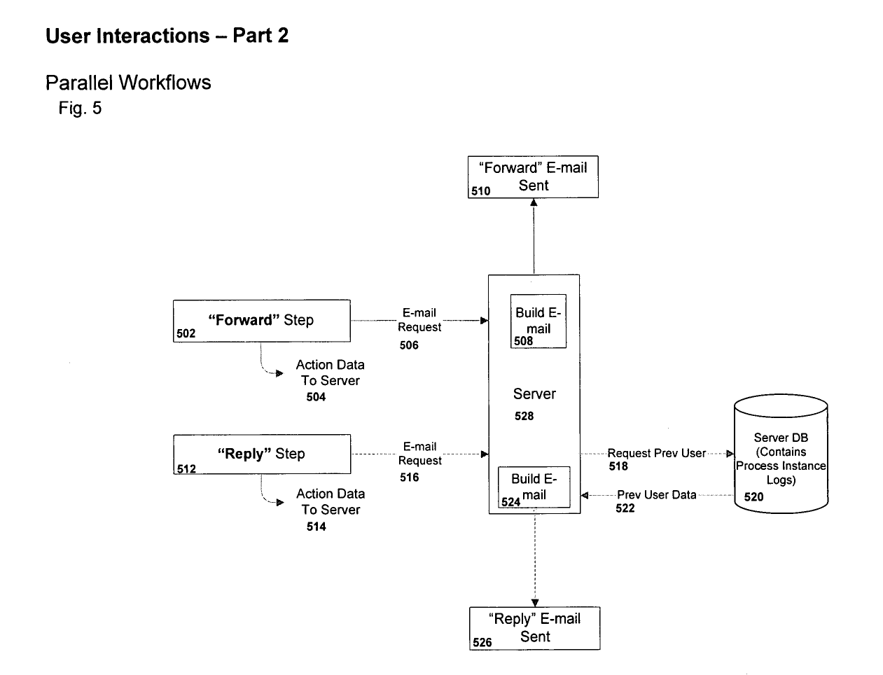

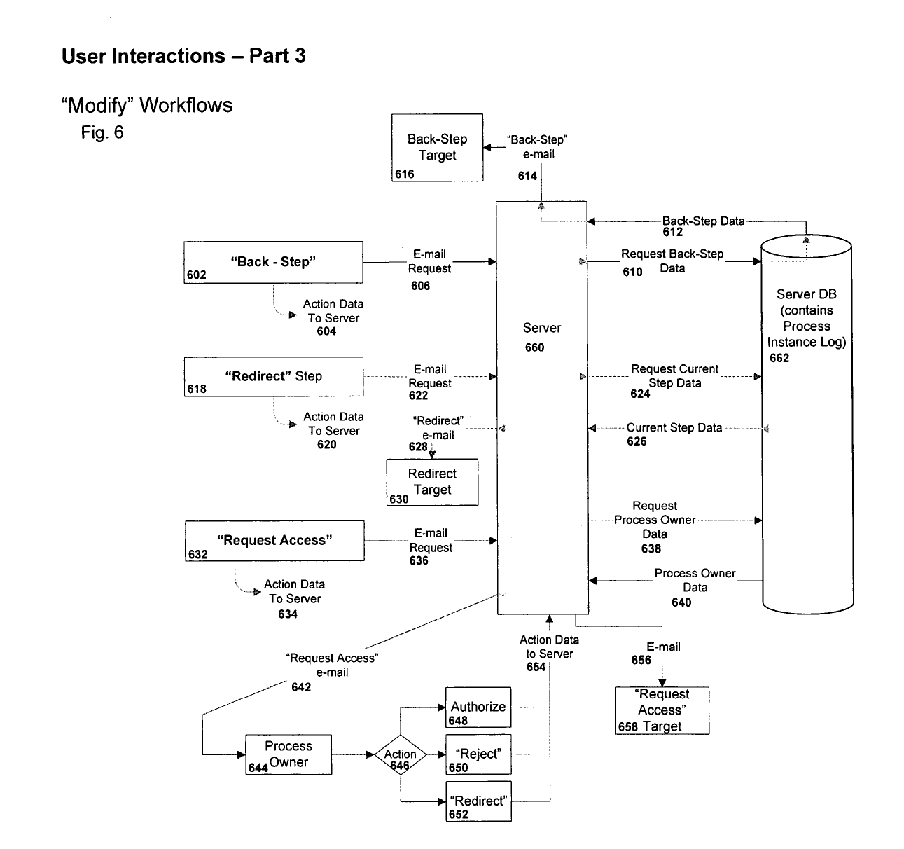

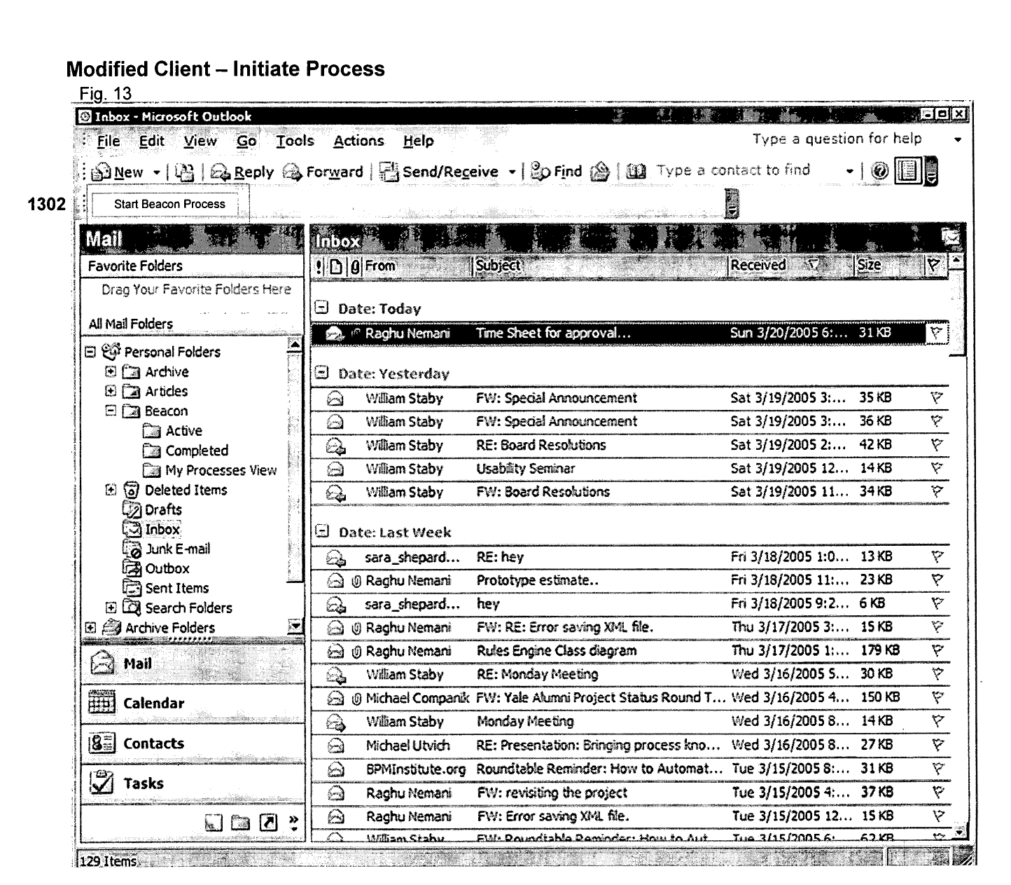

This item represents the enhanced client. The enhanced client allows users to perform certain additional workflow management tasks in addition to all normal e-mail functions. Using the enhanced client, users can take the following additional workflow-management actions:
Initiate a workflow (FIG. 13)
Partially or fully complete a step in a workflow (FIG. 4)
Initiate parallel workflows (FIG. 5)
Modify a workflow (FIG. 6)

The enhanced client is also used to display workflow-related information and interfaces and to relay user actions to the service. In addition, the enhanced client also collects and reports workflow and user-action data to the service.

Item 208—Initial Data Flow

This arrow represents the initial transmission (via e-mail) of step-related workflow data from the service to a user's enhanced client or vice-versa. This transmission may contain the following types of data:

Initial Data Request—if a user is authorized to initiate a particular workflow, the enhanced client will request necessary or updated forms from the service;

Form Data—data that describes the electronic form, or “container,” that the user will interact with to complete the workflow step. Examples of form data include: form field data, form submission timing data, form submission frequency data and custom data related to form-specific programming.

Enterprise Data—data from enterprise systems or databases to be displayed in the electronic form and which users will need to see at each workflow step. The term “Enterprise Data” broadly includes any data within enterprise systems, data stores, or other data sources which may be displayed, interacted with, or included within an electronic form at a process step.

Threaded Textual Data—a sequential log of all written communications that have taken place between workflow participants as the workflow has progressed from step to step e.g. dialog from previous steps, instructions, quoted conversations, etc.

Step-related Data—Meta-data regarding the workflow step e.g. process and step identification data, user data, step status and priority data, time the step began, was viewed and completed, etc.

Item 210—Data: User Entries

This arrow represents the sending of user requests back to the service from the enhanced client. These transmissions may occur via HTTP or web-service xml packets and may be triggered by user actions and rule evaluations at the enhanced client.

Sometimes user-submitted data may be passed through to other enterprise systems, or outside systems. For example, when a form is submitted to the service by a user, the data contained in the form would first travel to the service, which would then route the data through an appropriate adapter to the appropriate enterprise (or outside) system.

Item 212—Data: Service Responses

This arrow represents the responses from the service to the enhanced client. These transmissions occur via HTTP or web-service xml packets. These transmissions may be in response to: (i) user actions, (ii) rule-evaluations at the service, or (iii) instructions and actions dictated by external services.

Item 214—End-of-Step Data Flow

This arrow represents the transmission of step-related data from the enhanced client to the service that, through specific user action, administrator action or rules (internal or external) evaluation indicates that a workflow step has been completed.

Item 216—The Service Application
This item represents the service, which orchestrates the workflow e.g.:
creation, management and modification of workflows
handling of all enhanced client requests and transmissions
assembly of e-mails
data exchange with enterprise and outside systems
enforcement of form/data security
application of internal rules to execute workflows
application of external rules to execute workflows
logging of data regarding user and system actions and interactions

Item 218—Data Transmission to Database

This arrow represents the transmission of workflow and enterprise data between the service and a database application.

This data includes: form data, selected enterprise data, time data relating to step execution and related actions, step status, process workflow data (normal, parallel and modified), threaded dialog, etc.

Item 220—The Database

This item represents the service's database. This database may be running on the same platform or platforms as the service or on a separate designated platform and is, more generally, a data repository for holding the type(s) of data described herein.

Item 222—Enterprise Data Flow

This arrow represents the transmission of workflow and enterprise data between the service and various other enterprise systems.

Item 224—Enterprise Rules Flow

This arrow represents the transmission of information between the service and an external rules management application.

Item 226—Enterprise Systems

This item represents the variety of enterprise systems that may interact with the service while a workflow is being executed.

Item 228—Enhanced Client Installer

This item illustrates the fact that users without the enhanced client already installed on their local computer would initiate an interaction with the service that would guide the user through the enhanced client installation process.

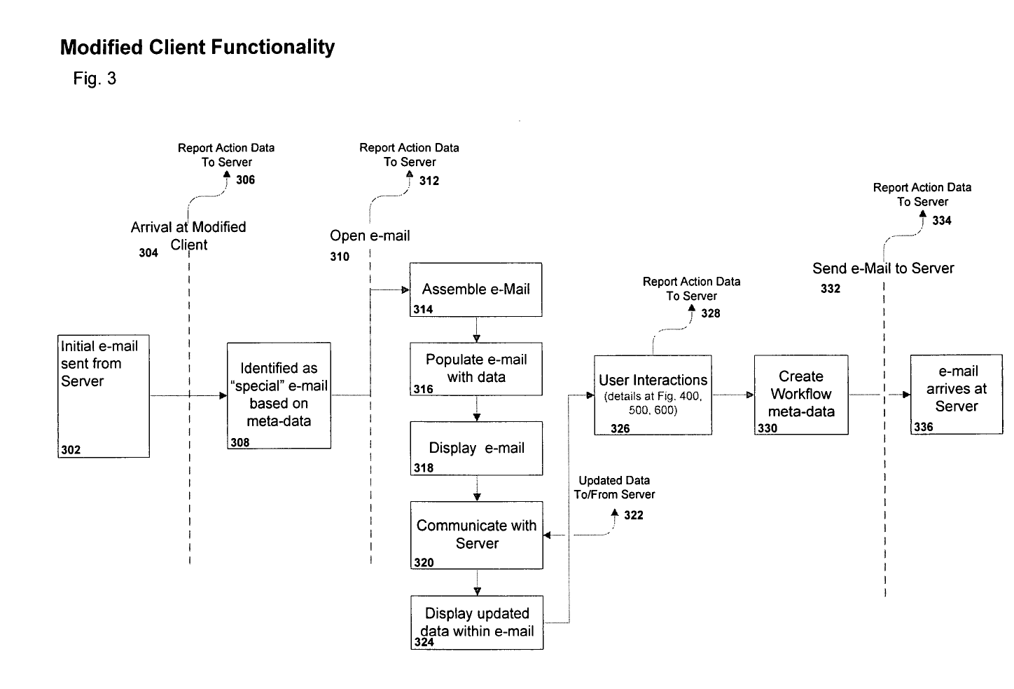

FIG. 3—Enhanced Client Functionality

FIG. 3 details user/enhanced client interactions described in item 204 as well as enhanced client and service actions in response to user/enhanced client interactions.

Item 302—Initial E-mail Sent from Service

This item represents an e-mail (or other electronic message) sent from the service to initiate a workflow step. The e-mail contains workflow step data and may also contain text, form and enterprise data.

Item 304—E-mail Arrives at Enhanced Client

This item represents the arrival of a service-generated e-mail at the enhanced client.

Item 306—Report Action Data to Service

This arrow represents the reporting of action data back to the service. This action is automatically executed by the enhanced client when an e-mail is delivered to the enhanced client and is in a form expected for reporting action data (for example, in the form of a web-service xml packet).

“Action data” includes: action execution data (e.g. form data state upon a form submission event), time-of-occurrence information, rule enforcement actions, process and step identification information, user information, user interaction information (i.e. clicking certain buttons, changing fields and related timing data), execution status, user-prompted modifications to the workflow, etc.

Item 308—Identified as “Special” E-Mail Based on Metadata

This item illustrates the fact that all in-coming e-mails are inspected and sorted by the enhanced client. E-mail messages are identified as “special” when the enhanced client detects the presence of custom metadata fields embedded within the e-mail.

Item 310—Opening an E-mail

This item represents the user-initiated action of opening an e-mail.

Item 312—Report Action Data to Service

This arrow represents the reporting of action data back to the service in the form of a web-service xml packet. This action is automatically executed by the enhanced client when an e-mail is opened by a user.

Item 314—Assemble an E-Mail

This item represents the assembly of the newly-opened e-mail by the enhanced client. The assembly process begins by loading the e-mail into a pre-defined template.

Item 316—Populate E-Mail with Data

This item represents the population of the e-mail template with step data, text, forms data, and enterprise data.

Item 318—Display E-Mail

This item represents the populated e-mail template being displayed to the user by the enhanced client.

Item 320—Communicate with Service

This item represents the fact that after the e-mail has been displayed, a custom web service communicates with the service and retrieves any data updates that may have occurred since the original e-mail was sent.

Item 322—Updated Data to/from Service

This arrow represents the fact that during the web-service call to the service for data updates, the action of opening the e-mail is logged by the service as is the action that updated data was called for and sent.

Examples of “updated data” requests includes: refresh data displayed in an electronic form (e.g. provide real-time stock quotes), instructions to modify the form (i.e. remove or add fields), messages or actions required based upon time related rules (e.g. terminate this step because it has taken too long, or initiate a reminder message because too much time has passed between certain actions) etc.

Item 324—Display Updated Data Within E-Mail

This item represents the enhanced client rendering updated data into the displayed e-mail.

Item 326—User Interactions

This item represents various user interactions with the enhanced client interface. Examples of the user's options in this area are further detailed in FIGS. 4, 5 and 6

Item 328—Report Action Data to Service

This arrow represents the fact that during a user interaction with the enhanced client, several actions will generate action data transmissions to the service, which will, in turn, log those actions.

Item 330—Create Workflow Step Meta-Data

This item shows that at the conclusion of user interactions with the enhanced client, the enhanced client aggregates form, step and workflow data, before transmitting it to the service via e-mail.

Item 332—Send E-Mail to Service

This arrow represents the action of the enhanced client transmitting (via e-mail) the aggregated form, step, and workflow data, to the service.

Item 334—Report Action Data to Service

This arrow represents the reporting of action data back to the service in the form of a web-service xml packet. This action is automatically executed by the enhanced client when the user indicates the completion of a workflow step.

Item 336—E-Mail Arrives at Service

This item represents a user's completed e-mail arriving at the service from the enhanced client.

FIG. 4—User Interactions Part 1: Serial Workflows

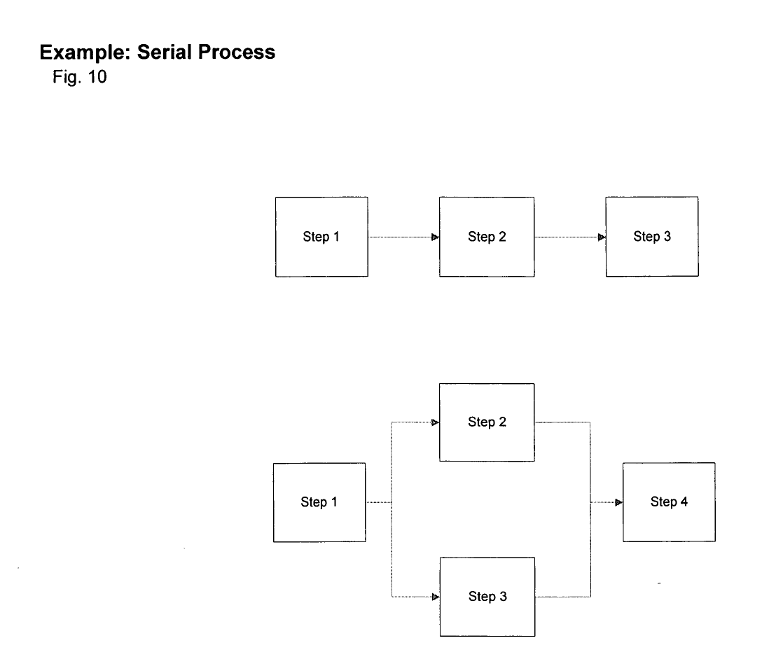

FIG. 4 depicts a set of user interactions with the enhanced client as generally described in Item 326 related to the completion of one step in a serial workflow i.e. one that has a series of dependent steps that occur in a precise, pre-planned order (see FIG. 10). Specifically, FIG. 4 depicts a set of user actions related to entering data and unstructured text into an e-mail and submitting it when complete or partially complete.

Item 402—Enter Data into Form

This item represents the user action of entering data into an html form contained within the e-mail. Data entry does not necessarily generate interactions with the service unless there are scripted rules embedded within the form that trigger automatic data evaluation (described in Item 406).

Item 404—Enter Unstructured Dialog

This item represents the user action of entering a text message into the e-mail. This action does not result in any interactions with the service.

Item 406—Data Request/Evaluation

This item represents a user-initiated (manual) or automatic (scripted) action to: (i) retrieve data from, or (ii) evaluate data entered into the html form by an outside system resource. An example of such an interaction would be an html form that automatically retrieves and displays live stock market quotes.

Item 408—Action Data to Service

This arrow represents the fact that certain data request/evaluation actions may generate action data transmissions to the service, which will log such actions in its database. These action data transmissions are sent via web-service xml packets, or HTTP.

Item 410—Data Request/Evaluation to Service

This arrow represents a data request directed to the service from the enhanced client. These transmissions are sent via web-service xml packets, or HTTP.

Item 412—Data Request/Evaluation to Enterprise Systems

This arrow represents the data request being passed by the service to an external system. The data request includes instructions on which adapters to use to access data from a particular external system. Data request transmissions are most commonly sent via web-service xml packets but adapters can be written to connect with external systems using any protocol.

Item 414—Data Request/Evaluation Results to Service

This arrow represents data being sent by an external system in reply to a service-generated data request transmission. The data packet includes the adapter ID and process instance data. Data transmissions are sent via web-service xml packets.

Item 416—Data Request/Evaluation Results to Enhanced Client

This arrow represents the data from the external system being re-formatted by the service to fit the form output to the form's evaluated data output display e.g. fields, text boxes, message area, web-media displays, etc. These transmissions may be sent via web-service xml packets.

Item 418—Form Submitted

This item represents the user action of submitting a completed, or partially completed, form. This action is triggered either: (i) manually by the user clicking on the “Complete” or “Save Draft” button in the enhanced client's button bar or by clicking on a “Submit” button embedded in the form itself, or (ii) automatically by scripted rules embedded within the form.

Item 420—Action Data to Service

This arrow represents action data being transmitted to the service when a form is submitted. The service logs the action data in its database and action data transmissions are sent to the service via HTTP.

Item 422—Form Data Submitted to Service

This arrow represents the transmission of form data to the service. The data will have been converted to an xml format and then submitted via HTTP.

Item 424—Form Data Submitted to Enterprise Systems

This arrow represents form data passing through the service and onward to appropriate enterprise data adapter, data validation and data submission systems. During the pass-through operation, certain of the form data may be captured and linked to other process instance variables such that discrete process instances can be identified by a user. This submission is sent via either HTTP, web-service xml packets or as an ODBC SQL statement.

Item 426—Validation Message from Enterprise Systems to Service

This arrow represents the fact that form data submitted to enterprise systems will generate validation responses to/from data adapter, data validation and data submission systems. These validation responses are returned to the service via HTTP, web-service xml packets or as ODBC SQL statements and are logged in the service's database.

Item 428—Status Message from Service to Form

This arrow represents the fact that validation responses from enterprise systems to the service generate, in turn, status responses from the service to the form. Status responses can be pointed to individual data fields within the form or can indicate the general success or failure of a form data submission. These may return to the enhanced client via HTTP, web-service xml packets or as ODBC SQL statements.

Item 430—Workflow Step Completed

This item represents actions initiated when all workflow step activities have been completed. “Complete” actions can be triggered: (i) manually when a user clicks the “Complete” button within the enhanced client, or (ii) automatically through the activation of scripted rules.

Item 432—Action Data to Service

This arrow represents action data being transmitted to the service when a workflow step has been completed. The service logs the action data in its database and action data transmissions are sent to the service via e-mail.

Item 434—Workflow Step Completion Notification

This arrow represents the fact that when a workflow step has been either manually or automatically determined to be complete, an end-of-step request is sent via e-mail to the service. This request will be evaluated by the service if pass/fail rules have been established.

Item 436—Request Next-Step Information

This arrow represents the fact that when a “complete” request has been approved by the service, the database is queried to determine the next step in the workflow. This query may be an ODBC request.

Item 438—Database Application Refers to Process Map

This item refers to the service's database which contains detailed process maps that have been created and stored by system administrators.

Workflow map data includes: xml structures describing the relationships of steps to one another; descriptions about the nature and execution of steps; current-step execution instructions; forms and connector information pertaining to specific steps; rule conditions and execution parameters related to steps, users, and data; and users and their related responsibilities and permissions.

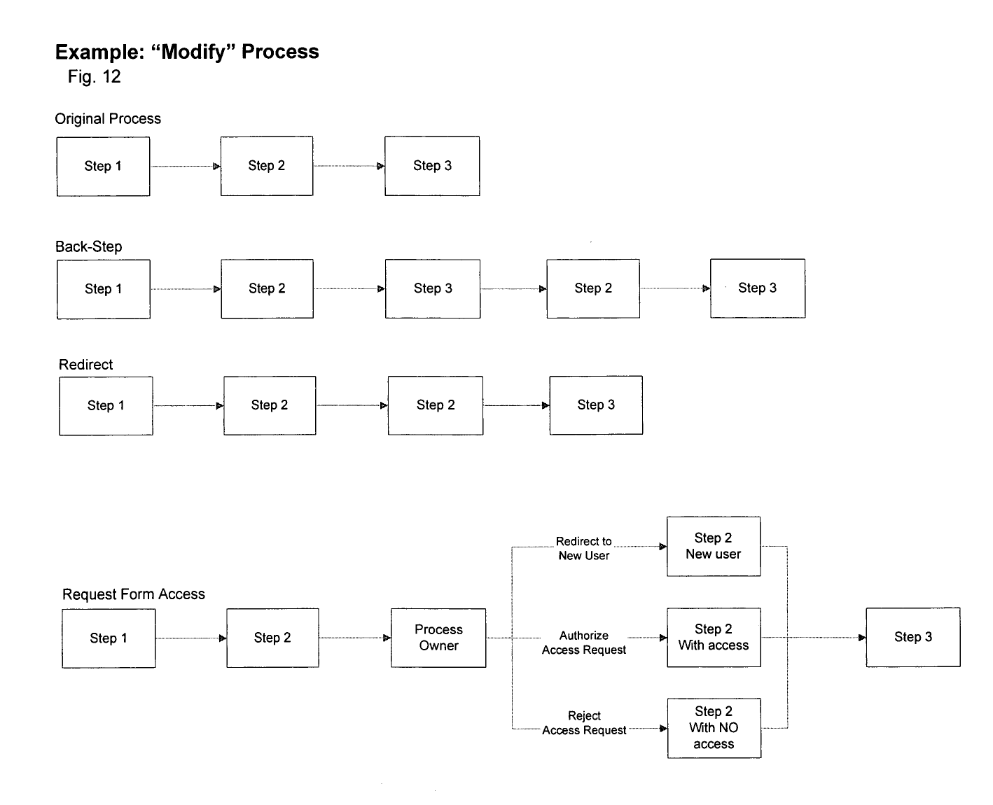

In cases where a process includes “modify” workflow actions (described in FIG. 6 and FIG. 12), process map data may also include data regarding the modified process instance.

Item 440—Next-Step Communication

This arrow represents the transmission of requested next-step information from a database to the service.

Item 442—Next-Step Execution

This item indicates that next-step information is used by the service to initiate the next step in the workflow, which may involve: (i) a user, (ii) a system resource, or (iii) an “END” log entry.

Item 444—The Service

This item represents the service which initiates requests, processes requests and handles communications between enhanced clients, enterprise systems, and its database.

Item 446—Enterprise Systems and Resources

This item represents the collection of different enterprise systems and resources that may need to interact with the service during the execution of a workflow. Examples of enterprise systems and resources include rules engines, database applications, mail directories and other software applications.

Item 448—“Save Draft”

This item represents the fact that a user may initiate a “save draft” action at any time after opening an e-mail to cause the current state of the data contained in the form to be saved at the enhanced client thus allowing the user to, if necessary, complete tasks in a piecemeal fashion over an extended period of time.

FIG. 5—User Interactions Part 2: Parallel Workflows

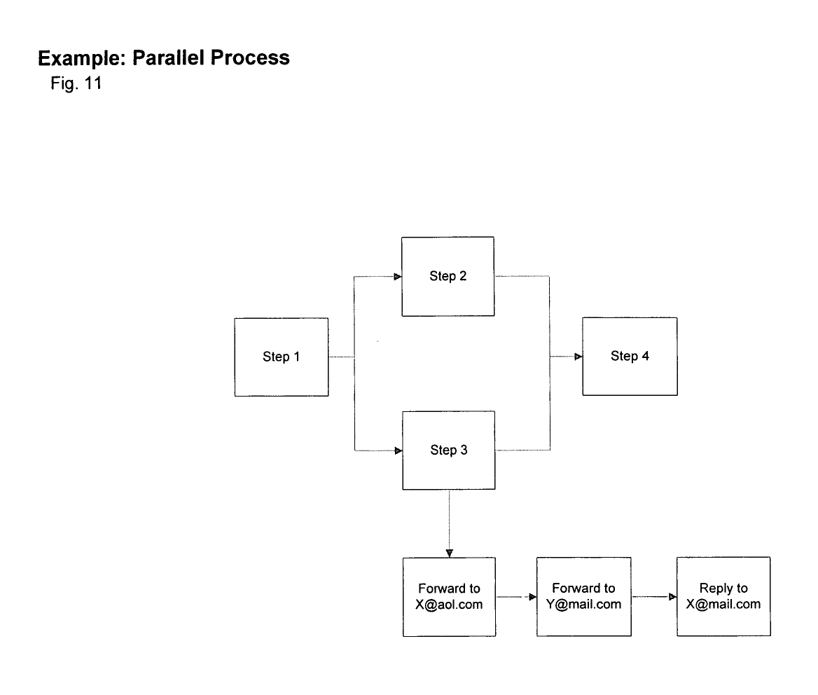

FIG. 5 depicts a set of user interactions with the enhanced client as generally described in Item 326 related to the execution of a parallel workflow i.e. a “branch” workflow that may operate concurrently with one or more other workflows yet is, for a period of time, independent of those other workflows (see FIG. 11). Specifically, FIG. 5 depicts a set of user and system actions related to a user: (i) forwarding an e-mail to another person who: (a) does not occupy the position of “next” in the workflow model, or (b) may be completely disconnected from the workflow; or (ii) replying to an e-mail.

Item 502—Initiating a “Forward” Action

This item represents the user action of forwarding an e-mail to an addressee that is either not “next” in the workflow or is completely outside the workflow. A user initiates this action by clicking the “Forward” button contained within the enhanced client and entering an addressee name in the appropriate place. A “Forward” action does not alter the original workflow and represents a parallel “branch” to the original workflow.

Item 504—Action Data to Service

This arrow represents action data being transmitted to the service when a “Forward” action has been initiated by a user. Action data transmissions are sent to the service via e-mail and are logged in its database.

Item 506—“Forward” Request Sent to Service

This arrow represents the “Forward” request, along with addressee, text, form, step and enterprise data, being sent via e-mail to the service.

Item 508—Service Builds E-mail

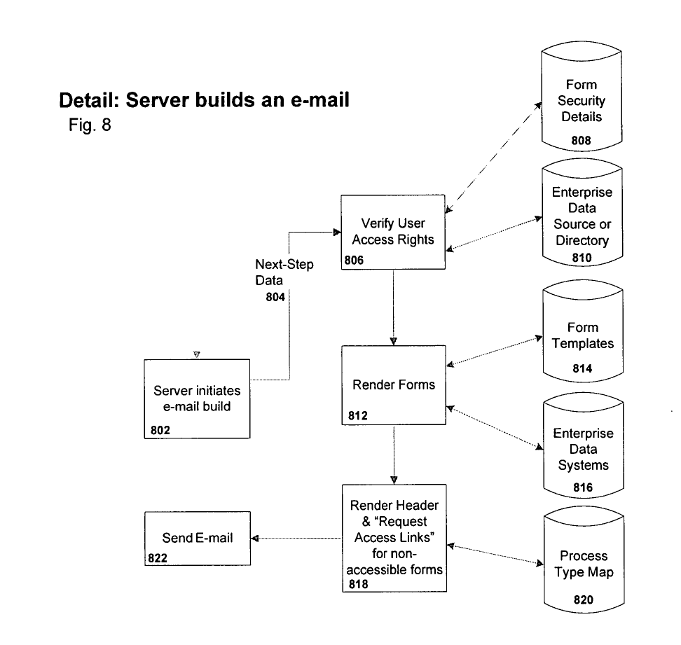

This item represents actions taken by the service to either: (i) reject the Forward request, (ii) build and forward to addressee an e-mail in “read-only” mode, or (iii) assemble and forward to addressee an e-mail that is fully interactive. An example process the service follows to build e-mails is detailed in FIG. 8.

Item 510—“Forward” E-mail Sent

This item represents a security-cleared e-mail being sent to the “Forward” addressee.

Item 512—Initiating a “Reply” Action

This item represents the user action of replying to an e-mail. A “Reply” e-mail may originate from someone who is not part of the workflow map. A user initiates this action by clicking the “Reply” button contained within the enhanced client. A “Reply” action does not alter the original workflow and represents a parallel “branch” to the original workflow.

Item 514—Action Data to Service

This arrow represents action data being transmitted to the service when a “Reply” action has been initiated by a user. Action data transmissions are sent to the service via e-mail and are logged in its database.

Item 516—“Reply” Request Sent to Service

This arrow represents the “Reply” request, along with updated text (e.g., “out of band” dialog between workflow participants and others), form, step and enterprise data, being sent via e-mail to the service.

Item 518—Lookup Previous-User Address

This arrow represents the service requesting previous-user address information from the process instance log contained within its database. This request may be sent via ODBC.

Item 520—The Service's Database

This item represents the service's database which contains the process instance logs and workflow maps. Process instance logs record certain information about every workflow being managed by the service as they occur and workflow maps guide the execution of serial workflows.

Process instance log data includes: workflow, modified workflow, parallel workflow, previous step, form, user, dialog, and related data as recorded during the execution of the current process to the present. This will include information required to rebuild the previous step (including form state at the end of that step, the user involved, dialog to that point, and other related information required to rendering the step) that is used when executing a reply to a previous user.

For a description for workflow map data, please see Item 438.

Item 522—Return Previous-User Information

This arrow represents the database returning information about the previous user from the process instance log to the service. This reply is sent via ODBC.

Item 524—Service Builds E-mail

This item represents actions taken by the service to build an e-mail that contains all user-updated text, form, step and enterprise data. A process the service may follow to assemble e-mails is detailed in FIG. 8.

Item 526—“Reply” E-mail Sent

This item represents the “Reply” e-mail being conveyed back to the previous user.

Item 528—The Service

This item represents the service.

FIG. 6—User Interactions Part 3: “Modify” Workflows

FIG. 6 depicts a set of user interactions with the enhanced client as generally described in Item 326 related to the execution of “modify” workflows i.e. where a user has selected “redirect,” “back-step,” or “request access” actions (see FIG. 12). These actions are called “modify” workflows because they represent changes in the core workflow whereas “Reply” and “Forward” actions represent workflows that occur in parallel to the core workflow.

Item 602—Initiating a “Back-Step” Action

This item represents the “back-step” user action which, in most cases, indicates the rejection by the current-step user of the previous step. A user might select “back-step” when, for example, data contained in the form from a previous step is incomplete or inaccurate and requires rework (i.e. during an approval process). The “back-step” button runs the workflow model from the beginning of the transaction block. The back-step feature would not be used at the first workflow step.

“Transaction blocks” are set up by system administrators and define a series of steps that delineate a specific sub-set of the workflow. The first user in a transaction block, the “back-step target,” is given a second opportunity (and comments) to correct or update data, or comments which led to the use of the “back step” interaction by a user within the transaction block (see FIG. 12).

Item 604—Action Data to Service

This arrow represents action data being transmitted to the service when a “Back-Step” action has been initiated by a user. Action data transmissions are sent to the service via e-mail and are logged in its database.

Item 606—“Back-Step” Request to Service

This arrow represents the transmission of the “back-step” action request to the service. This request is sent by e-mail.

Item 610—Request “Back-Step” Data

This arrow represents the service requesting “back-step” related data i.e. addressee, text, form, step and enterprise data from the process instance log contained within its database. This request is sent by ODBC.

Item 612—Return “Back-Step” Data

This arrow represents the database returning back-step data based on information contained in the process instance log. Return data is sent by ODBC.

Item 614—“Back-Step” E-mail Delivered to Back-Step Target

This arrow represents the service sending a “back-step” e-mail to the back-step target. Such e-mails are assembled according to the process described in FIG. 8.

Item 616—Back-Step Target

This item represents the back-step target—the recipient of a “back-step” e-mail. The back-step target will see the entire e-mail as originally displayed to the “back-step” action initiator plus any contextual dialog the “back-step” action initiator may have added.

Item 618—Initiating a “Redirect” Action

This item represents the “redirect” user action which, in most cases, is used to pass responsibility for the completion of a particular step to another user (the “redirect target”).

Item 620—Action Data to Service

This arrow represents action data being transmitted to the service when a “redirect” action has been initiated by a user. Action data transmissions are sent to the service via e-mail and are logged in its database.

Item 622—“Redirect” Request to Service

This arrow represents the transmission of the “redirect” action request to the service. This request is sent by e-mail.

Item 624—Request Current-Step Data

This arrow represents the service requesting current-step data i.e. addressee, text, form, step and enterprise data from the process instance log contained within its database. This request is sent by ODBC.

Item 626—Return Current-Step Data

This arrow represents the database returning current-step data based on information contained in the process instance log. Return data is sent by ODBC.

Item 628—“Redirect” E-mail Delivered to Redirect Target

This arrow represents the service sending a “redirect” e-mail to the redirect target. Such e-mails may be built according to the process described in FIG. 8.

Item 630—Redirect Target

This item represents the recipient of a “redirect” e-mail. This person will see the entire e-mail as originally sent to the “redirect” action initiator plus any comments made by the “redirect” action initiator.

Item 632—Initiating a “Request Access” Action

This item represents the “request access” user action which is normally undertaken by a user when he/she lacks sufficient access rights and, as a result, an “access denied” message is generated. A “request access” action is directed to a process owner.

Item 634—Action Data to Service

This arrow represents action data being transmitted to the service when a “request access” action has been initiated by a user. Action data transmissions are sent to the service via e-mail and are logged in its database.

Item 636—“Request Access” Request to Service

This arrow represents the transmission of the “request access” action request to the service. This request is sent by e-mail.

Item 638—Request Process Owner and Form Data

This arrow represents the service requesting data about the process owner as well as data used to rebuild the current-step e-mail i.e. addressee, text, form, step and enterprise data from the process instance log. This request is sent by ODBC.

Item 640—Return Process Owner and Form Data

This arrow represents the database returning data about the process owner as well as data the service uses to rebuild the current-step e-mail. Return data is sent by ODBC.

Item 642—“Request Access” E-mail Delivered to Process Owner

This arrow represents the service sending a “request access” e-mail to the process owner. Such e-mails are built according to the process described in FIG. 8.

Item 644—The Process Owner

This item represents the process owner. A “process owner” is defined as the person who has been designated as having overall responsibility for the efficient operation of a particular workflow and the authority to grant or deny “request access” requests.

Item 646—Possible Process Owner Actions

This item represents the process owner's response options:
“Authorize” the form access request;
“Reject” the form access request; or
“Redirect” the form access request to someone else.

Item 648—“Authorize” Form Access Request

This item represents the case when the process owner chooses to “authorize” the form access request by selecting the “authorize” button embedded in the “request access” e-mail.

An “authorize” action results in the service building the appropriate e-mail, including updated text provided by the process owner, and sending it back to the “request access” action initiator.

Item 650—“Reject” Form Access Request

This item represents the case when the process owner chooses to “reject” the form access request by selecting the “reject” button embedded in the “request access” e-mail.

A “reject” action results in the service building the appropriate e-mail, including updated text provided by the process owner, and sending it back to the “request access” action initiator.

Item 652—“Redirect” Form Access Request

This item represents the case when the process owner chooses to “redirect” the form access request by selecting the “redirect” button embedded in the “request access” e-mail.

A “redirect” action results in the service building the appropriate e-mail, including updated text provided by the process owner, and (i) sending it onward to the “redirect” user for further action, and (ii) sending an “access request forwarded” message to the “request access” action initiator.

Item 654—Action Data to Service

This arrow represents action data being transmitted to the service when a “request access” request has been acted upon by a process owner. Action data transmissions are sent to the service via e-mail and are logged in its database.

In addition to typical action data submitted, information regarding the process owner's decision will be added to the xml structure of the process instance log to record the “request access” workflow scenario executed in this case.

Item 656—E-mail sent to “Request Access” Target

Depending upon the process owner's response to item 646, this arrow represents the fact that the service has built the appropriate e-mail in accordance with the process detailed in FIG. 8 and has conveyed it to the “request access” target via e-mail.

Item 658—The “Request Access” Target

This item represents the “request access” target who will receive an e-mail if the process owner has selected the “accept” or “redirect” options outlined in item 646.

Item 660—The Service

This item represents the service.

Item 662—The Service's Database

This item represents the service's database which contains the process instance logs and workflow maps. Process instance logs record certain information about every workflow being managed by the service as they occur and workflow maps guide the execution of serial workflows.

For a description of workflow map data, please see Item 438.

For a description for process instance log data, please see Item 520.

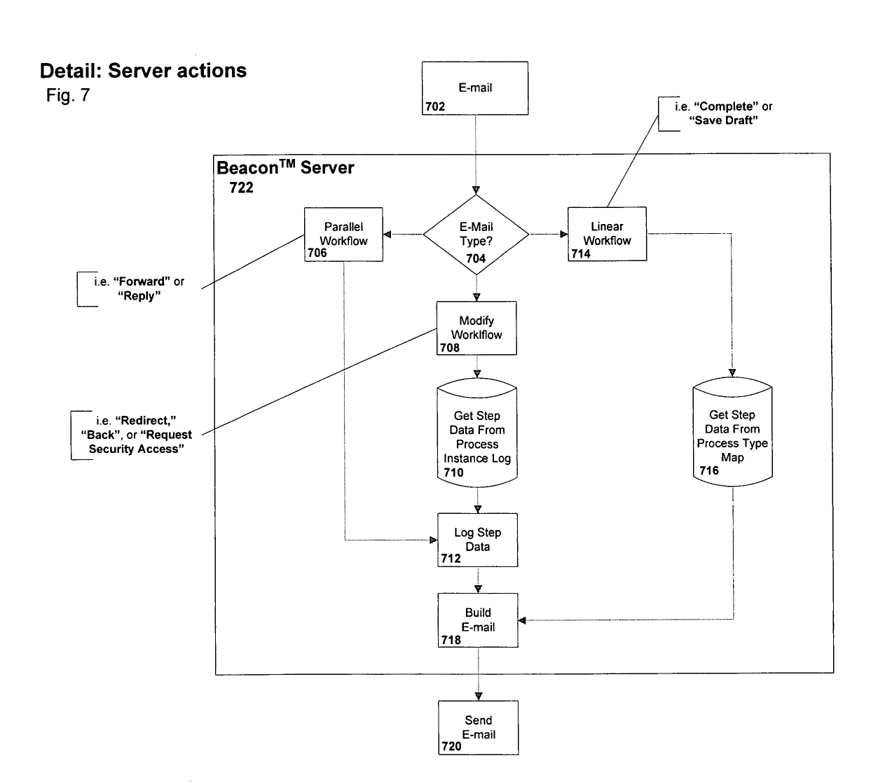

FIG. 7—Service Actions

FIG. 7 depicts actions taken by the service when various user actions detailed in FIGS. 4, 5 and 6 are triggered.

Item 702—E-Mail Sent to Service

This item represents an e-mail of one of three different types being sent to the service. The three basic types of e-mails represent:
serial workflows
parallel workflows
“modify” workflows

Item 704—Evaluate E-Mail Type

This item shows that in-coming e-mails are evaluated and processed by the service according to type.

Item 706—Parallel Workflow E-Mails

This item represents an e-mail that has been identified as a “parallel workflow” e-mail i.e. that the user has specified a “forward” or “reply” action be taken.

Item 708—“Modify” Workflow E-Mails

This item represents an e-mail that has been identified as a “modify” workflow e-mail i.e. that the user has specified a “back step,” “re-direct” or “request security access” action be taken.

Item 710—Retrieve Step Data from Process Instance Log

This item represents the service making a call to its database to retrieve data about “modify” workflow e-mails from the process instance log. This request is made via ODBC.

Item 712—Log Workflow Step Data

This item represents the extra step required to log workflow data related to parallel workflow and modify workflow e-mails into the process instance log. Serial workflows do not require such an extra step because they involve users and data flows that are already contained in the workflow map.

Item 714—Serial Workflow E-Mails

This item represents an e-mail that has been identified as a “serial workflow” e-mail i.e. that the user has specified a “complete” or “save draft” action be taken. In these two instances, workflow advances according to the workflow map contained in the database.

Item 716—Retrieve Next Step Data

This item represents the service referring to the workflow map within the service's database to obtain information about the next step. This action only occurs when a user submits an e-mail using the “complete” button.

Item 718—Build E-Mail

This item represents the service building e-mails according to the process detailed in FIG. 8.

Item 720—Send E-Mail

This item represents the delivery of an e-mail to the next-step user in the workflow.

Item 722—The Service

This item represents the service.

FIG. 8—The E-mail Building Module

FIG. 8 depicts how the service builds an e-mail.

Item 802—Service Initiates Request to Build Next-Step E-mail

This item represents the service initiating a request to build an e-mail after determining (as described in FIG. 7) that next-step information is contained in: (i) the workflow map if the user has specified a “serial workflow” action; or (ii) the process instance log if the user has specified a “parallel workflow” or “modify workflow” action.

Item 804—Next-step Data Conveyed to E-mail Building Module

This arrow represents next-step data being conveyed to the e-mail building module.

Item 806—User Access Rights Verified

This item represents the first step in the process of building a next-step e-mail—verification of user access rights—wherein next-step user and composition information (i.e. form and enterprise data to be rendered) are evaluated against the security settings assigned to: (i) the next-step user, and (ii) the next-step enterprise data to be rendered in the form.

Item 808—Form Security Details

This item shows that form security information is stored in the service's database and is used to describe which individuals, groups or roles may access and interact with a particular form. Individual, group and role information may originate from a pre-existing LDAP compatible directory.

Form security information is initially defined by a system administrator when the form is first created but can be subsequently modified by either: (i) consent of a process owner, or, (ii) another person with authorization to access the system.

The form security details data store includes information such as: form identifier, default security settings (including a user/group list), step-level security data (including a user/group list), security setting information which may describe the permissible scenarios for a user without proper access rights, process-level security data, etc.

Item 810—Enterprise Data Source or Directory

This item depicts various enterprise systems that may be accessed to verify user access rights. For example, enterprise directory services may be queried to determine if the next-step user actually belongs to the specific role or group which has been granted access to a restricted form.

The enterprise data source or directory includes data such as: user identifier information, user identifier information in a directory service, user group membership information, user security access info, user status information (i.e. position, department, schedule and calendar-related information, current status, etc), group identifier information, group security access information, etc.

Item 812—Render Accessible Forms

This item represents the subsequent action of building the next-step e-mail. After access rights have been verified, the next-step form(s) will be rendered into XHTML. This involves a two-step process of: (i) accessing stored form templates, and (ii) polling enterprise data systems.

Item 814—Form Template Database

This item depicts the service's database which contains a library of form templates. Form templates are descriptions of data presentation, data interaction and data entry interfaces for user interactions at the enhanced client level. Form templates are normally created by system administrators. Form template access requests are executed via ODBC.

Examples of form template data include: frame, field, formatting and other information related to the rendering of a form, validation code or pointers to validation code, related interfaces (i.e. web services or other services/code to be executed related to the use of a form), form security information, related rules to be called or executed in relation to a form, connector information so that outside systems and services can interact with a form, etc.

Item 816—Enterprise Data Systems

This item depicts the various enterprise data systems that may be called upon to populate a form with enterprise data. This data may be retrieved in a variety of ways including ODBC, HTTP, and Web-service xml packets.

Item 818—Render “Access Denied” Message and “Request Access” Link for Non-accessible Forms

This item represents service actions if a next-step user is denied access rights to enterprise data within a form. In this case, the service renders an “access denied” message that includes a general description of denied content as well as a “request access” link to the process owner.

Item 820—Workflow Map

This item represents the service querying the workflow map contained within its database to determine the process owner associated with this workflow. This query is done via ODBC.

Item 822—Send E-Mail

This item represents the service sending an e-mail to a next-step user.

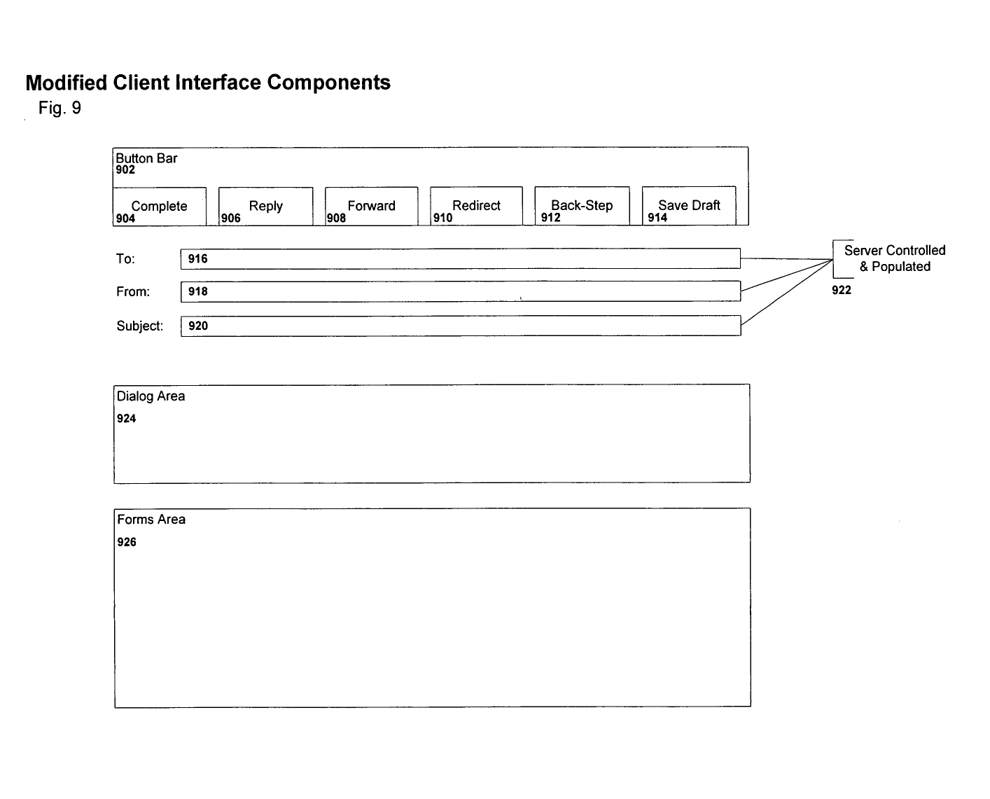

FIG. 9—Enhanced Client Interface Components

FIG. 9 shows the basic components of the enhanced client interface.

Item 902—The Enhanced Client Button Bar

This item represents an additional button bar that the enhanced client installer adds to a basic e-mail client e.g. Microsoft Outlook™ and Lotus Notes™.

Item 904—The “Complete” Button

This item represents the “complete” button, used to indicate that a workflow step has been fully completed and is ready to proceed to the next step. “Complete” actions initiate “serial workflow” e-mails as detailed in FIG. 4.

Item 906—The “Reply” Button

This item represents the “reply” button, used to establish a parallel dialog with the previous-step user. The “reply” button is one of two buttons that initiate “parallel workflow” e-mails as detailed in FIG. 5. The “reply” button is disabled at the first workflow step.

Item 908—The “Forward” Button

This item represents the “forward” button, used to establish a parallel dialog with another user. The “forward” button is one of two buttons that initiate “parallel workflow” e-mails as detailed in FIG. 5. The “forward” e-mail recipient is designated by entering an e-mail address in the “to” field (item 916).

Item 910—The “Redirect” Button

This item represents the “redirect” button, used to pass responsibility for the completion of a workflow step to a different user. The “redirect” button is one of two buttons that initiate “modify workflow” e-mails as detailed in FIG. 6. The “redirect” e-mail recipient is designated by entering an e-mail address in the “to” field (item 916).

Item 912—The “Back-Step” Button

This item represents the “back-step” button, used to reject work done by the previous-step user. The “back-step” button is one of two buttons that initiate “modify workflow” e-mails as detailed in FIG. 6. The “back-step” button is not used at the first workflow step.

Item 914—The “Save Draft” Button

This item represents the “save draft” button, to allow current-step users to save a draft of their work and return to it at a later time. “Save draft” actions do not advance the workflow to the next step.

Item 916—The “To” Field

This item represents the “to” field to automatically displays the e-mail address of the scheduled next-step user. The “to” field is also an active data-entry field that may be used to capture the address of an intended next-step e-mail recipient in “redirect” and “forward” workflows.

Item 918—The “From” Field

This item represents the “from” field, to automatically display the e-mail address of the previous-step user. The “from” field is display-only.

Item 920—The “Subject” Field

This item represents the “subject” field, to automatically display workflow step data and process type and instance data. User-initiated changes to the “subject” field will not carry through to the next-step user unless the next-step is a “forward” or “reply” action.

Item 922—The “to,” “from” and “subject” Fields are Service-Controlled

This item represents that data contained within the “to,” “from” and “subject” fields are populated by the service.

Item 924—The Dialog Area

This item represents the dialog area, used for normal text entry in the same manner as any other electronic messaging medium. The dialog area also displays a sequential record of all written communications that may have taken place during previous workflow steps.

Item 926—The Forms Area

This item represents the forms area where various forms are displayed along with related enterprise data. Forms are rendered in the forms area using xhtml. The forms area allows direct connections to the service for live data feeds via web-service based xml packets and also through HTTP and secured protocols like SSL.

FIG. 10—Two Examples of Serial Processes

FIG. 10 includes two illustrations of serial workflow patterns. In the lower of the two illustrations, despite the fact that the workflow pattern branches in two directions, it is still a serial workflow pattern because the completion of each step occurs without deviation from the pattern originally detailed in the workflow map.

FIG. 11—An Example of a Parallel Process

FIG. 11 is an illustration of a series of parallel workflow interactions. In this case, the workflow represented by the “branch” at step 3 takes place independently from the workflow that occurs in steps 1-4. In the example, this represents a conversation not represented in the workflow that occurs separately from, and on an independent timeline from the rest of the process. This conversation may continue well after the workflow itself has completed. This branch was initiated by a reply or forward of Step 3, initiated by the user at Step 3.

FIG. 12—Examples of “Modify” Processes

FIG. 12 illustrates three “modify” processes: (1204) back-step; (1208) re-direct; and (1212) “request form access.”

Item 1202—Original Workflow

Item 1202 depicts a normal workflow pattern executed with normal interactions (as described in FIG. 4). As such, it follows the path of the workflow map. Item 1202 is used as the basis for the three “modify” process examples in FIG. 12.

Item 1204—Back Step

Item 1204 is an example of a back-step work flow (see FIG. 6, item 602).

Item 1206—Initiate Back-Step

Item 1206 represents the user at Step 3 initiating a back-step action.

Item 1208—Redirect

Item 1208 is an example of a redirect workflow (see FIG. 6, item 618).

Item 1210—Initiate Redirect

Item 1210 represents the user at Step 2 initiating a redirect action, to pass responsibility for this step's completion to someone else.

Item 1212—Request Access

Item 1212 is an example of a “request form access” workflow (see FIG. 6, Item 632).

Item 1214—Initiate “Request Form Access”

Item 1214 represents the user at Step 2 lacking access rights to data contained within an electronic form and, therefore, initiating a “request form access” action.

Item 1216—Process Owner

Item 1216 represents the process owner receiving a copy of the Step 2 user's step e-mail which now includes a mechanism for initiating one of the three resolution options (see FIG. 6. Items 644-652).

FIG. 13—Enhanced Client—The “Start Process” Button

FIG. 13 depicts an example of an enhanced client application—in this case Microsoft Outlook™—with the “start process” button in context.

Item 1302—The “Start Process” Button

This item depicts the “start process” button within the context of a particular e-mail client application. To initiate a workflow, a user may simply click this button and a drop-down menu offers an array of workflows to initiate. The array is pre-determined according to the rights and responsibilities of the user to initiate various workflows.

What is claimed is:

1. A method of interoperating with an electronic messaging service to manage the execution of a business process, the method comprising:
a. causing the electronic messaging service to present business process data to business process participants in enhanced electronic messages whereby business process participants can interact with the enhanced electronic messages; and
b. receiving reactions of business process participants to the enhanced electronic messages via the electronic messaging service.

2. The method of claim 1 further comprising communicating business process data between the business process participants and at least one data store via the enhanced electronic messages.

3. The method of claim 2 wherein the data stores are internal and external to the enterprise.

4. The method of claim 3 wherein the internal data store is an enterprise database.

5. The method of claim 1 wherein step “a” (above) includes:
a. interacting with a business process template and, based thereon, determining a sequence of steps of the business process; and
b. causing the enhanced electronic messages to be populated with process data based on the business process template.

6. The method of claim 5 wherein interacting with the business process template includes processing rules and definitions contained within the business process template.

7. The method of claim 6 wherein the rules and definitions are further contained within enterprise systems.

8. The method of claim 5 wherein interacting with the business process template further includes processing data from data stores.

9. The method of claim 8 wherein the data stores are either internal or external to the enterprise.

10. The method of claim 5 further comprising the generation of the business process template.

11. The method of claim 10 wherein an administrator generates the business process template.

12. The method of claim 10, wherein the business process template is generated based on an execution of a business process.

13. The method of claim 1 wherein the enhanced electronic messages include forms for conveying process data to business process participants and for receiving the reactions of the business process participants.

14. The method of claim 13 wherein the forms include fields for displaying and receiving process data from business process participants.

15. The method of claim 14 further comprising processing process data in relation to rules associated with the fields.

16. The method of claim 1 further comprising associating unstructured information in the enhanced electronic messages with structured process data.

17. The method of claim 16 wherein the unstructured information includes text contained within the enhanced electronic messages.

18. The method of claim 17 wherein the text contained within the enhanced electronic messages includes text written by the business process participants in reaction to enhanced electronic messages.

19. The method of claim 1 further comprising the recording of business process participant actions with respect to the business process.

20. The method of claim 19 wherein business process participants are persons or machines.

21. The method of claim 1 further comprising processing enterprise data and modifying the business process based at least in part thereon.

22. A method of enhancing an electronic messaging service to facilitate participation in a business process, comprising:
a. providing computer program code configured to cause the electronic messaging service to present business process data to business process participants in enhanced electronic messages; and
b. providing computer program code configured to receive the reactions of business process participants to the enhanced electronic messages via the electronic messaging service.

23. The method of claim 22 further comprising providing computer program code configured to, when executed, initiate the business process.

24. The method of claim 23 wherein the computer program code configured to initiate the business process is configured to initiate the business process is configured to initiate the business process based on the command of a business process participant.

25. The method of claim 22 further comprising providing computer program code configured to cause a completed enhanced electronic message to be received and processed by an electronic messaging service.

26. The method of claim 25 wherein computer program code is configured to cause a completed enhanced electronic message to be received by the electronic messaging service based on the command of a business process participant.

27. The method of claim 22 further comprising providing computer program code configured to modify the business process.

28. The method of claim 27 wherein the computer program code configured to modify the business process modifies the business process based on a condition.

29. The method of claim 28 wherein the condition is a business process participant command.

30. The method of claim 28 wherein the condition is a condition of a system.

31. The method of claim 22 further comprising providing computer program code configured to capture contextual dialog from a business process participant and to associate the captured contextual dialog with the business process.

32. The method of claim 31 wherein captured contextual dialog is associated with specific steps of the business process

33. The method of claim 31 wherein the contextual dialog includes dialog among business process participants regarding the business process.

34. The method of claim 33 wherein the dialog among business process participants includes reply and forward dialog.

35. The method of claim 27 wherein modifying the business process includes re-assigning responsibility for a portion of the business process.

36. The method of claim 27 wherein modifying the business process includes causing the occurrence of a back step in the business process.

37. The method of claim 22 wherein the computer program code configured to receive the reactions of the business process participants to enhanced electronic messages via the electronic messaging service includes computer program code configured to receive and process data provided by a business process participant.

38. A method of configuring an electronic messaging service to manage the execution of a business process within an enterprise, the method comprising:
a. generating a business process template including defining characteristics of steps of a business process; and
defining data entries templates corresponding to the steps; and
b. configuring the electronic messaging service to access the generated business process template.
